(19) United States
(12) Patent Application Publication
(10) Pub. No.: US 2011/0192250 A1
(43) Pub. Date: Aug. 11, 2011

(54) RACK BAR SUPPORTING DEVICE OF STEERING APPARATUS FOR VEHICLE

(75) Inventor: Jin Won CHUNG, Wonju-si (KR)

(73) Assignee: MANDO CORPORATION

(21) Appl. No.: 13/022,223

(22) Filed: Feb. 7, 2011

(30) Foreign Application Priority Data
Feb. 10, 2010 (KR) 10-2010-0012208

(51) Int. Cl. B62D 1/20; B62D 1/19

(52) U.S. Cl. 74/496

(57) ABSTRACT

Disclosed is a rack bar supporting device of a steering apparatus for a vehicle. The disclosed rack bar supporting device reduces the friction between a rack bar and a support yoke during the rack bar's linear motion interlocking with the operation of a steering wheel. Thus, the device can prevent free movement from increasing by reducing the wear of the support yoke, and can facilitate the restoration of the steering wheel by the reduction of the friction between the rack bar and the support yoke when a driver drives a vehicle in a forward direction after the operation of the steering wheel. Also, it is possible to prevent a noise from occurring caused by an increase of free movement when the support yoke collides with a yoke plug by an impact revelry input from an uneven road surface, etc. This provides a comfortable steering feeling to the driver.

### CROSS-REFERENCE TO RELATED APPLICATION

This application claims priority from and the benefit under 35 U.S.C. §19(a) of Korean Patent Application No. 10-2010-0012208, filed on Feb. 10, 2010, which is hereby incorporated by reference for all purposes as if fully set forth herein.

### BACKGROUND OF THE INVENTION

1. Field of the Invention

The present invention relates to a rack bar supporting device of a steering apparatus for a vehicle. More particularly, the present invention relates to a rack bar supporting device of a steering apparatus for a vehicle, wherein the device reduces the friction between a rack bar and a support yoke during the rack bar's linear motion interlocking with the operation of a steering wheel, and thus it can prevent free movement from increasing by reducing the wear of the support yoke, can facilitate the restoration of the steering wheel by the reduction of the friction between the rack bar and the support yoke when a driver drives a vehicle in a forward direction after the operation of the steering wheel, and can prevent a noise from occurring caused by an increase of free movement so as to provide a comfortable steering feeling to the driver when the support yoke collides with a yoke plug by an impact revelry input from an uneven road surface, etc.

2. Description of the Prior Art

In general, a steering apparatus is an apparatus which allows a driver to freely change an advancing direction of a vehicle. In other words, the apparatus is an assist apparatus which allows a driver to freely change a rotation center of turning of a front wheel of the vehicle and to advance the vehicle in a required direction.

FIG. 1 is a schematic configuration view illustrating a conventional rack and pinion type steering apparatus.

As shown, the conventional rack and pinion type steering apparatus includes: a steering wheel 100 disposed in a driver's seat; a steering shaft 105 connected to the steering wheel 100; a steering column 103 configured to fix the steering shaft to a vehicle body; a gear box 130 including a rack gear 110 and a pinion gear 120 which convert a rotation force received from the steering shaft 105 into a linear motion; a rack bar 140 provided with inner ball joints 135 at both ends thereof, and a tie rod 150 integratedly formed with a ball of each of the inner ball joints 135.

Also, the tie rod 150 is connected to an outer ball joint 155 and transfers a force to a knuckle 159, so as to steer a tire 158.

FIG. 2 is a cross-sectional view illustrating a conventional rack bar supporting device.

As shown, the conventional rack bar supporting device includes a pinion gear 120, a rack bar 140, a support yoke 260, a spring 263, and a yoke plug 265. A rack and pinion type gear box 130, as described above, converts a rotation force received from a steering shaft (not shown) into a linear motion. The rack bar 140 converts a rotary motion into a linear motion by meshing with the pinion gear 120. At the rear surface of the rack bar 140, a device for supporting the rack bar 140 toward the pinion gear 120 is provided so as to facilitate the mesh of the rack bar 140 and the pinion gear 120.

The device for the rack bar 140 includes the support yoke 260, the spring 263, and the yoke plug 265. The support yoke 260 is positioned at the opposite side to the formation surface of the rack gear 110 (see FIG. 1) as the rear surface of the rack bar 140, and has a structure in which it can move in front/rear directions perpendicular to the rack bar 140 by being inserted in a cylinder 250 of the gear box 130.

The support yoke 260 has a cylindrical shape so that it can slide in the front/rear directions within the cylinder 250. Also, at the support yoke 260's front side contacting with the rack bar 140, a semicircular groove is formed so as to closely contact with the rear surface of the rack bar 140.

Also, at the rear side of the support yoke 260, the spring 263 is disposed so that the rack bar 140 and the pinion gear 120 can closely contact with each other and effectively transfer a force. The spring 263 pushes the support yoke 260 at a predetermined pressure so as to compensate free-movement occurring between the rack bar 140 and the pinion gear 120.

The support yoke 260 as described above slidingly rubs against the rear surface of the rack bar 140. Thus, in order to prevent the rack bar 140 from being worn or a noise from occurring by friction, the support yoke 260 is made of a plastic material softer than the conventional rack bar 140.

The spring 263 received in a spring groove 220 has a function of pressing the support yoke 260 in such a manner that the support yoke 260 can closely contact with the rack bar 140. In general, as the spring 263, a coil spring is used. At the rear surface of the spring 263, the yoke plug 265 is positioned so as to support the spring 263.

The yoke plug 265 supports the spring 263 in such a manner that the spring 263 can press the support yoke 260. In the yoke plug 265, in general, a screw thread and a screw groove are formed so that they can couple with the gear box 130 and a lock nut 240, the gear box 130 and the lock nut 240 being formed with another screw thread and another screw groove to mesh with them. At the rear surface of the yoke plug 265, a tool groove 230 into which a wrench can be inserted is formed.

However, the conventional rack bar supporting device as described above has a problem in that due to high friction, as the support yoke is worn to some extent, it cannot sufficiently support the rack bar by an increase of free movement. Furthermore, there is a problem in that due to the increase of free movement, a rattle noise occurs in the support yoke and the yoke plug.

Also, there is a problem in that the rattle noise occurring by free movement due to wear and the insufficient supporting of the rack bar reduce the stability of steering.

Also, when free movement occurs by the wear of the support yoke, the displacement of the spring coupled to compensate free movement increases by the increased free movement. This reduces tension of the spring. Thus, there is a structural problem in that even though the same impulse is added, the noise is increased.

### SUMMARY OF THE INVENTION

Accordingly, the present invention has been made to solve the above-mentioned problems occurring in the prior art, and the present invention provides a rack bar supporting device of a steering apparatus for a vehicle, wherein the device reduces the friction between a rack bar and a support yoke during the rack bar's linear motion interlocking with the operation of a steering wheel, and thus it can prevent free movement from increasing by reducing the wear of the support yoke, and can prevent a noise from occurring caused by an increase of free movement so as to provide a comfortable steering feeling to the driver when the support yoke collides with a yoke plug by an impact revelry input from an uneven road surface, etc.

In order to accomplish this object, there is provided a rack bar supporting device of a steering apparatus for a vehicle, the rack bar supporting device including: a support yoke inserted in a gear box to support a rack bar in a front direction; and a yoke plug configured to support the support yoke toward the rack bar, wherein the support yoke includes: a hollow shaft support inserted in a cylinder of the gear box; a roller shaft insertedly coupled with an inside of the shaft support; a roller having a curved outer peripheral surface corresponding to a rear surface of the rack bar, and a center portion coupled with the roller shaft, which rotates on a center of the roller shaft and supports the rack bar in the front direction by interlocking with a linear motion of the rack bar; and a ball bearing coupled between the roller shaft and the roller so as to support rotation of the roller and support a load transferred from a central axis of the rack bar in a radial direction.

The device according to the present invention reduces the friction between a rack bar and a support yoke during the rack bar's linear motion interlocking with the operation of a steering wheel. Thus, it can reduce the wear of the support yoke, thereby preventing free movement from increasing.

Also, the reduction of the friction between the rack bar and the support yoke can facilitate the restoration of the steering wheel when a driver drives a vehicle in a forward direction after the operation of the steering wheel.

Also, it is possible to prevent a noise from occurring caused by an increase of free movement between the support yoke and the rack bar when the support yoke collides with a yoke plug by an impact revelry input from an uneven road surface, etc. This provides a comfortable steering feeling to the driver.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic configuration view illustrating a conventional rack and pinion type steering apparatus for a vehicle;

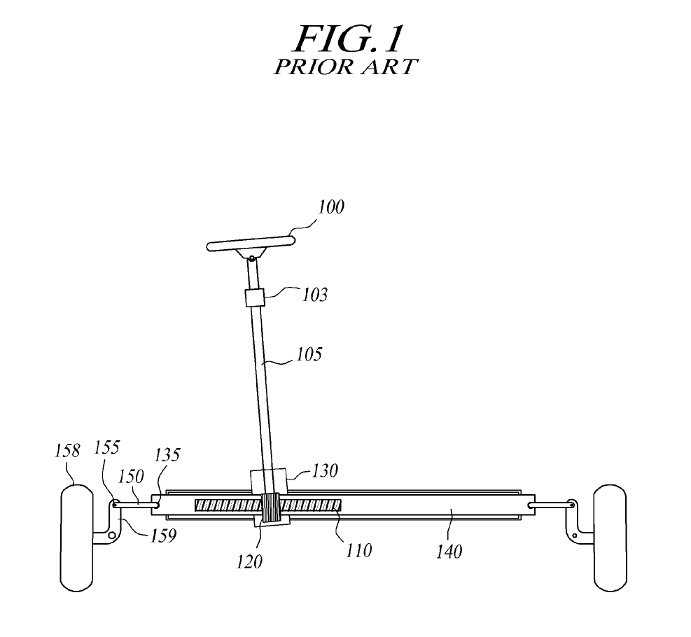

FIG. 2 is a cross-sectional view illustrating a conventional rack bar supporting device;

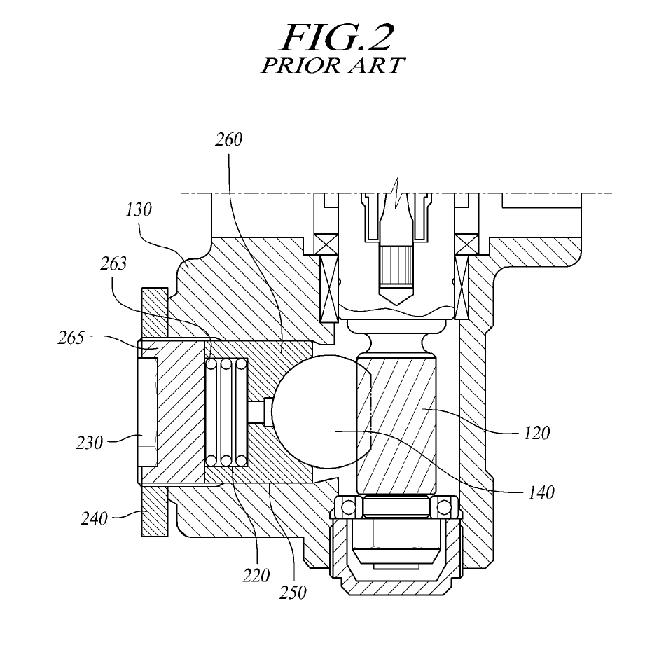

FIG. 3 is a cross-sectional view illustrating a rack bar supporting device for a vehicle, according to a first embodiment of the present invention;

FIG. 4 is a cross-sectional view illustrating a rack bar supporting device for a vehicle, according to a second embodiment of the present invention; and

FIG. 5 is a cross-sectional view illustrating a rack bar supporting device for a vehicle, according to a third embodiment of the present invention.

### DETAILED DESCRIPTION OF THE PREFERRED EMBODIMENTS

Hereinafter, exemplary embodiments of the present invention will be described in detail with reference to the accompanying drawings. In reference numerals given to components of respective drawings, it should be noticed that the same components are designated by the same reference numerals as far as possible although they are illustrated in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

In the detailed description of the present invention, unless specially mentioned, for convenience of description, a direction of a rack bar, at the front side of a support yoke, is referred to as a front direction, and the opposite direction, at the rear side of the support yoke, is referred to as a rear direction.

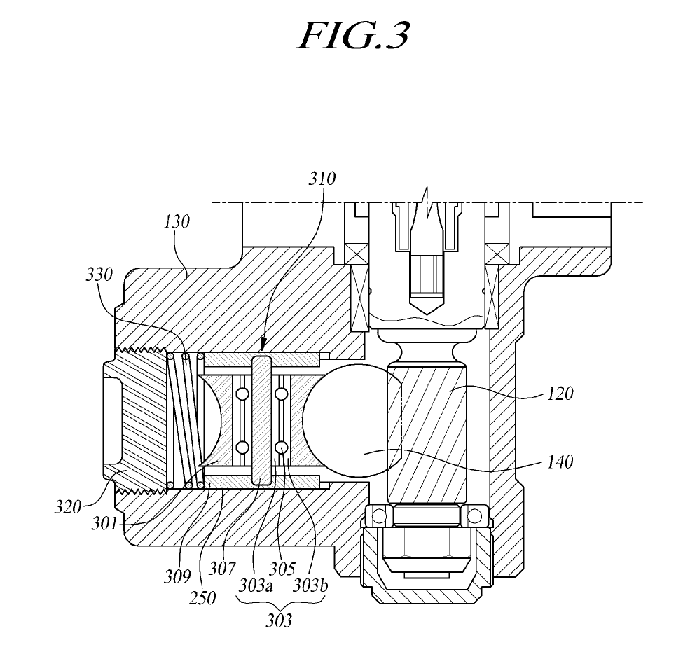

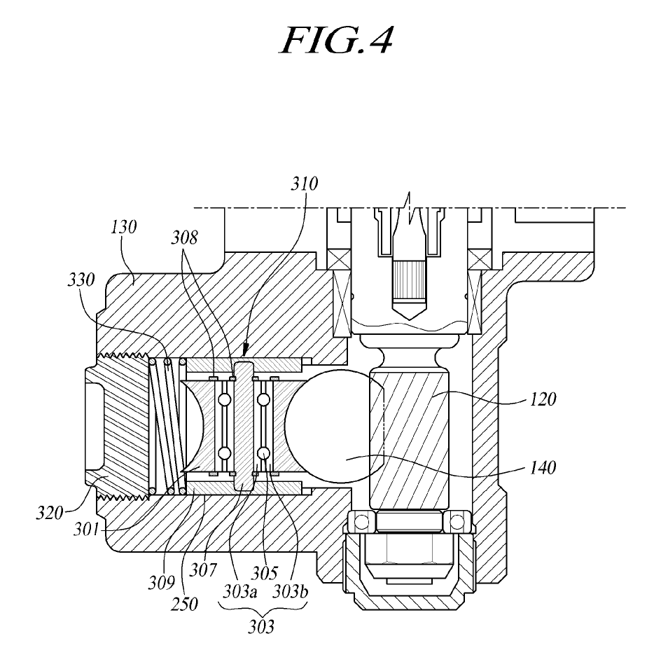

FIG. 3 is a cross-sectional view illustrating a rack bar supporting device for a vehicle, according to a first embodiment of the present invention, and FIG. 4 is a cross-sectional view illustrating a rack bar supporting device for a vehicle, according to a second embodiment of the present invention.

As shown in FIGS. 3 and 4, a rack bar supporting device of a steering apparatus for a vehicle, according to the first and second embodiments of the present invention, includes: a support yoke 310 inserted in a gear box 130 so as to support a rack bar 140 in the front direction; and a yoke plug 320 for supporting the support yoke 310 toward the rack bar 140. The support yoke 310 includes: a hollow shaft support 309 inserted in a cylinder 250 of the gear box 130; a roller shaft 307 insertedly coupled with the inside of the shaft support 309; a roller 301 having a curved outer peripheral surface corresponding to the rear surface of the rack bar 140, and a center portion coupled with the roller shaft 307, which rotates on the center of the roller shaft 307 and supports the rack bar 140 in the front direction by interlocking with a linear motion of the rack bar 140; and a ball bearing 303 coupled between the roller shaft 307 and the roller 301 so as to support the rotation of the roller 301 and support the load transferred from the central axis of the rack bar 140 in a radial direction.

Also, between the yoke plug 320 and the shaft support 309, an elastic support 330 is coupled, which is supportedly coupled with the end portion of the shaft support 309. The elastic support supports the whole of the support yoke 310 including the shaft support 309 in the front direction while absorbing the external force transferred via the rack bar 140.

The support yoke 310 closely contacts with the rear surface of the rack bar 140 meshing with a pinion gear 120 and supports the rack bar 140 in the front direction in such a manner that the rack bar 140 can easily mesh with the pinion gear 120.

The support yoke 310 as described above is configured to rotate by interlocking with a linear motion of the rack bar 140 in such a manner that it can avoid the friction with the rack bar 140 while the rack bar 140 and the pinion gear 120 contact with each other to effectively transfer a force.

In other words, the support yoke 310 is inserted in the cylinder 250 of the gear box 130 so as to closely support the rear surface of the rack bar 140 at the front side of the support yoke. Meanwhile, at the rear side, the yoke plug 320 is combined with the cylinder 250 of the gear box 130 so as to push the support yoke 310 in the front direction.

The support yoke 310 as described above, which is supported by the yoke plug 320 in the front direction toward the rack bar 140, includes the shaft support 309, the roller shaft 307, the roller 301, and the ball bearing 303 in order to minimize the friction with the rack bar 140.

The shaft support 309 is insertedly coupled with and fixed to the cylinder 250 of the gear box 130 so that the roller 301 rotating by interlocking with the linear motion of the rack bar 140, and the roller shaft 307 as the rotation center of the roller 301 can be coupled and supported. Also, the shaft support 309 is formed in a hollow tube shape within which the roller shaft 307 and the roller 301 can be positioned.

Within the shaft support 309 as described above, the roller shaft 307 is insertedly coupled. Also, at both ends of the inside surface at the center of the shaft support 309, shaft groves to which the roller shaft 307 is coupled are formed in such a manner that the roller shaft 307 formed in a pin shape can be coupled and supported.

The roller 301 rotates while its center portion is coupled with the roller shaft 307s. Its outer peripheral surface is formed in a curved shape corresponding to the rear surface of the rack bar 140, and it is configured to rotate on the center of the roller shaft 307 by interlocking with a linear motion of the rack bar 140.

Such a roller 301 reduces the friction with the rack bar 140 through rotation while supporting the rack bar 140 in the front direction by the elastic support 330's force supporting the shaft support 309. This reduces free movement between the roller 301 and the rack bar 140. Thus, it is possible to prevent a rattle noise from occurring caused by a large free movement between the rack bar 140 and the roller.

Meanwhile, between the roller shaft 307 and the roller 301, the ball bearing 303 is coupled so as to support the rotation of the roller 301. The inserted ball bearing 303 supports the load transferred from the central axis of the rack bar 140 in a radial direction.

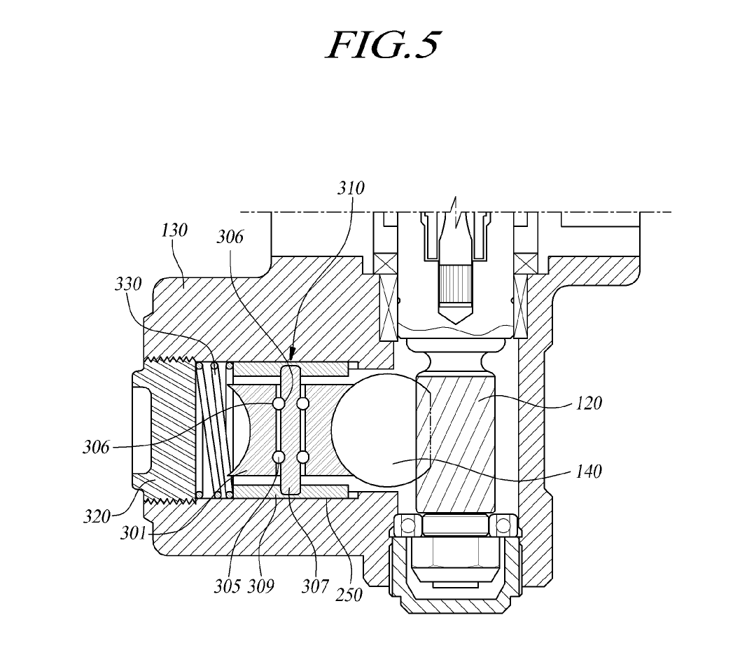

Such a ball bearing 303, like the embodiments according to the present invention, as shown in FIGS. 3 and 5, may be coupled in various structures.

The ball bearing 303, like the first and second embodiments as shown in FIGS. 3 and 4, includes an inner wheel 303a coupled with the outer circumferential surface of the roller shaft 307, an outer wheel 303b coupled with the roller 301, and at least one ball 305 inserted between the inner wheel 303a and the outer wheel 303b.

First, in the first embodiment shown in FIG. 3, the ball bearing 303 is pressedly coupled between the roller shaft 307 and the roller 301.

In other words, in the ball bearing, the inner wheel 303a and the outer wheel 303b are coupled without an additional fixing member in such a manner that the inner wheel 303a is pressed in the outer circumferential surface of the roller shaft 307, and the outer wheel 303b is pressedly coupled with the inner circumferential surface of the roller 301.

The ball bearing 303 in the second embodiment as shown in FIG. 4 has a structure in which the bearing is inserted between the roller shaft 307 and the roller 301, and is combined with the outer circumferential surface of the roller shaft 307 by lock rings 308 at one side end and the other side end of the roller 301.

In other words, since an impact transferred from an uneven road surface via the rack bar 140 may cause the ball bearing 303 to escape, the ball bearing 303 has a structure in which it is forcedly combined with the roller shaft 307 by the lock rings.

FIG. 5 is a cross-sectional view illustrating a rack bar supporting device for a vehicle, according to a third embodiment of the present invention.

As shown in FIG. 5, a rack bar supporting device of a steering apparatus for a vehicle, according to the third embodiment of the present invention, includes: a support yoke 310 inserted in a gear box 130 so as to support a rack bar 140 in the front direction; and a yoke plug 320 for supporting the support yoke 310 toward the rack bar 140. The support yoke 310 includes: a hollow shaft support 309 inserted in a cylinder 250 of the gear box 130; a roller shaft 307 insertedly coupled with the inside of the shaft support 309; a roller 301 having a curved outer peripheral surface corresponding to the rear surface of the rack bar 140, and a center portion coupled with the roller shaft 307, which rotates on the center of the roller shaft 307 and supports the rack bar 140 in the front direction by interlocking with a linear motion of the rack bar 140; and balls 305 coupled between the roller shaft 307 and the roller 301 so as to support the rotation of the roller 301 and support the load transferred from the central axis of the rack bar 140 in a radial direction, wherein the balls 305 are coupled with one or more concave grooves 306 formed in the outer circumferential surface of the roller shaft 307 and in the inner circumferential surface of the roller 301.

In the third embodiment, in the outer circumferential surface of the roller shaft 307 and in the inner circumferential surface of the roller 301, one or more concave grooves 306 are formed, and in the concave grooves 306, the balls 305 are directly coupled. Herein, the concave grooves 306 are formed in a circumferential direction in the outer circumferential surface of the roller shaft 307 and in the inner circumferential surface of the roller 301.

With the formed one or more concave grooves 306, the plurality of balls 305 are coupled, respectively. In this manner, by coupling the balls 305 between the roller shaft 307 and the roller 301, the rotation of the roller 301 is supported. Thus, it is possible to support the load transferred through the rack bar 140 at various angles.

In other words, the load transferred through the rack bar 140 is transferred from the central axis of the rack bar 140 in a radial direction, while the support yoke 310 supports the rack bar 140 at the rear side of the rack bar 140. Then, when the load is transferred from the central axis of the rack bar 140 to the support yoke 310 in a radial direction, the one or more provided balls 305 carry out rolling friction of the load transferred along the curved surface of the roller 301 in a direction approaching the transfer direction of the load. This increases the supporting force of the roller 301 and facilitates the rotation, thereby reducing the friction.

The device with the above described configuration and shape, according to the present invention, reduces the friction between a rack bar and a support yoke during the rack bar's linear motion interlocking with the operation of a steering wheel. Thus, it can reduce the wear of the support yoke, thereby preventing free movement from increasing.

Also, the reduction of the friction between the rack bar and the support yoke can facilitate the restoration of the steering wheel when a driver drives a vehicle in a forward direction after the operation of the steering wheel.

Also, it is possible to prevent a noise from occurring caused by an increase of free movement when the support yoke collides with a yoke plug by an impact revelry input from an uneven road surface, etc. This provides a comfortable steering feeling to the driver.

Even though it was described above that all of the components of an embodiment of the present invention are coupled as a single unit or coupled and operated as a single unit, the present invention is not limited to such an embodiment. That is, within the purpose of the present invention, all of the components may be selectively coupled and operated as one or more units.

In addition, since terms, such as “including,” “comprising,” and “having” mean that one or more corresponding components may exist unless they are specifically described to the contrary, it shall be construed that one or more other components can be included rather than excluded.

Although a technical scope of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A rack bar supporting device of a steering apparatus for a vehicle, the rack bar supporting device comprising:
a support yoke inserted in a gear box to support a rack bar in a front direction; and
a yoke plug configured to support the support yoke toward the rack bar,
wherein the support yoke comprises:
a hollow shaft support inserted in a cylinder of the gear box;
a roller shaft insertedly coupled with an inside of the shaft support;
a roller having a curved outer peripheral surface corresponding to a rear surface of the rack bar, and a center portion coupled with the roller shaft, which rotates on a center of the roller shaft and supports the rack bar in the front direction by interlocking with a linear motion of the rack bar; and
a ball bearing coupled between the roller shaft and the roller so as to support rotation of the roller and support a load transferred from a central axis of the rack bar in a radial direction.

2. The rack bar supporting device of the steering apparatus for the vehicle as claimed in claim 1, wherein between the yoke plug and the shaft support, an elastic support is coupled, wherein the elastic support is supportedly coupled with the shaft support, and supports the shaft support in the front direction while absorbing an external force transferred via the rack bar.

3. The rack bar supporting device of the steering apparatus for the vehicle as claimed in claim 1, wherein the ball bearing comprises an inner wheel coupled with an outer circumferential surface of the roller shaft, an outer wheel coupled with the roller, and at least one ball inserted between the inner wheel and the outer wheel.

4. The rack bar supporting device of the steering apparatus for the vehicle as claimed in claim 3, wherein the ball bearing is pressedly coupled between the roller shaft and the roller.

5. The rack bar supporting device of the steering apparatus for the vehicle as claimed in claim 3, wherein the ball bearing is inserted between the roller shaft and the roller, and is coupled at one side end and the other side end of the roller by lock rings combined with the roller shaft.

6. A rack bar supporting device of a steering apparatus for a vehicle, the rack bar supporting device comprising:
a support yoke inserted in a gear box to support a rack bar in a front direction; and
a yoke plug configured to support the support yoke toward the rack bar,
wherein the support yoke comprises:
a hollow shaft support inserted in a cylinder of the gear box;
a roller shaft insertedly coupled with an inside of the shaft support;
a roller having a curved outer peripheral surface corresponding to a rear surface of the rack bar, and a center portion coupled with the roller shaft, which rotates on a center of the roller shaft and supports the rack bar in the front direction by interlocking with a linear motion of the rack bar; and
balls coupled between the roller shaft and the roller so as to support rotation of the roller and support a load transferred from a central axis of the rack bar in a radial direction, wherein the balls are coupled with one or more concave grooves formed in an outer circumferential surface of the roller shaft and in an inner circumferential surface of the roller.

7. The rack bar supporting device of the steering apparatus for the vehicle as claimed in claim 6, wherein the concave grooves are formed in a circumferential direction in the outer circumferential surface of the roller shaft and in the inner circumferential surface of the roller.
